(19) United States
(12) Patent Application Publication
(10) Pub. No.: US 2016/0090178 A1
(43) Pub. Date: Mar. 31, 2016

(54) Leverage Pitch Link

(71) Applicant: Blair John Paynton, Kelowna (CA)

(72) Inventor: Blair John Paynton, Kelowna (CA)

(21) Appl. No.: 14/858,056

(22) Filed: Sep. 18, 2015

Related U.S. Application Data
(60) Provisional application No. 62/056,694, filed on Sep. 29, 2014.

(51) Int. Cl. B64C 27/605

(52) U.S. Cl. CPC B64C 27/605

(57) ABSTRACT

A leveraged pitch link control system for rotary-wing aircraft with pitch links attached to the rotor blade grips, main rotor and rotating swashplate. The pitch links are connected to the main rotor at an unequal distance from their center to create leverage during the cyclic and collective pitch control movements of the swashplate. The pitch links are attached to the rotor blade grips, main rotor and rotating swashplate with energy absorbing connectors and bearings.

### CROSS-REFERENCE TO RELATED APPLICATIONS

U.S. Provisional application No. 62/056,694, dated Sep. 29, 2014.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

(1) The Field of the Invention

The technical field is control systems for rotors.

(2) The Background Art

In the past, control of a rotary-wing aircraft is affected through cyclic and collective pitch control. Blade pitch control of a rotary-wing aircraft main rotor system was typically achieved through a swashplate assembly which transfers the motion of nonrotating servo-driven control members within a stationary field to the rotating members within a rotational field.

The swashplate assembly generally included two rings connected by a series of bearings with one swashplate ring connected to the airframe/gearbox (stationary field) and the other swashplate ring connected to a rotor hub (rotational field).

Apart from rotary motion, the rotationally stationary and rotational swashplate otherwise move as a unitary component. The swashplate assembly also includes a pivoted link device typically refererred to as a “scissors” to coordinate rotationally stationary or rotational swashplate motion within the respective field.

Each scissor assembly includes an upper link and a lower link each attached together through a bolt and respective journal-thrust bearing. The lower link of the rotating scissor assembly is typically attached to the rotating swashplate by a spherical bearing. A similar arrangement exists for the stationary scissor assembly. The rotary-wing control arms were attached to the rotor blade grip and the swash plate by a direct vertical pitch linkage. This design resulted in vibrations and shocks being transmitted from the rotor blades down the vertical pitch links and through the swashplate into the body of the rotary-wing aircraft. The more severe the air turbulence was on the rotor blades, the greater the vibration and shock being transmitted throughout the airframe. Overtime, constant wear resulted in damaged parts and injured pilots. Furthermore, the traditional direct pitch linkage design required connections between the rotor blade grip and the swash plate that were susceptible to wear. Therefore, constant repairs and maintenance are required.

Another disadvantage of the traditional direct pitch link is the amount of force required by the pilot to change the blade pitch. Due to the size of the rotor blades any change in pitch by the pilot requires a significant amount of energy to move the controls.

### BRIEF SUMMARY OF THE INVENTION

It is the primary objective of the invention to improve the cyclic and collective pitch control of rotary-wing aircraft by 1) reducing vibration and shock caused by rotor blades and 2) improve the operating efficiency by utilizing leveraged pitch links that require less energy and fewer repairs and maintenance. The invention is attached to the rotor blade grip, the main rotor shaft and the swashplate arm with vibration and shock dampeners within the connectors. The present invention comprises upper and lower leverage pitch links, dampeners and connectors.

The invention is attached to the rotor blade grips, main rotor shaft and the rotational swashplate with connectors. As the main rotor shaft turns, the connected invention (leveraged pitch links) also rotate with the rotational swashplate. Cyclic and collective pitch control are achieved by the angle and vertical movement of the rotational swashplate.

### BRIEF DESCRIPTION OF THE SEVERAL VIEWS OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a side perspective view of a traditional rotary-wing aircraft main rotor;

FIG. 2 is a side perspective view of the present invention disconnected;

FIG. 3 is a side perspective view of the present invention connected and the traditional main rotor of FIG. 1;

FIG. 4 is a side perspective view of one side of the present invention of FIG. 3 attached to the traditional main rotor of FIG. 1;

FIG. 5 is a side perspective view of both sides of the present invention of FIG. 3 attached to the traditional main rotor of FIG. 1;

FIG. 6 is a side view or the present invention disconnected;

FIG. 7 is a side view of the present invention connected;

FIG. 8 is a top view of the present invention disconnected;

FIG. 9 is a top view of the present invention connected.

### DESCRIPTION LIST

10: an embodiment of the invention.

11: main rotor head assembly

12: blade holder

13: upper leveraged pitch link mount

14: main shaft leveraged pitch link mount

15: main shaft

16: rotational swashplate

17: non-rotational swashplate

18a: lower leveraged pitch link

18b: upper leveraged pitch link

19: 18b upper pitch link mount

20: 18b lower pitch link mount

21: 18a upper pitch link mount

22: 18a middle pitch link mount

23: 18a lower pitch link mount

24: lower swashplate mounting bracket opening

25: swashplate mounting bracket

26: upper swashplate mounting bracket opening

Benefits of the rotary-wing aircraft Leveraged Pitch Link:

1) an improved design for the pitch links connecting the rotating swashplate and the blade grips that utilizes less energy and requires less maintenance.

2) connection of the leveraged pitch links to the main rotor shaft with bushings and bearings to absorb vibration and shock from the rotor blades.

3) leverage reduces the energy and travel required for rotor blade cyclic and collective pitch control.

4) vibration and shock dampening hardware incorporated into the connection points of the leveraged pitch links.

5) increased lift capacity due to leveraged pitch links allows for either larger loads or less energy use.

6) leverage pitch links provide opportunity for new blade design to improve lift and flight characteristics.

### DETAILED DESCRIPTION OF THE INVENTION

It will be readily understood that the components of the present invention, as generally described and illustrated in the drawings herein, could be arranged and designed in a wide variety of different configurations. Thus, the following more detailed description of the embodiments of the assembly and method of the present invention, as represented in the drawings, is not intended to limit the scope of the invention, as claimed, but is merely representative of various embodiments of the invention. The illustrated embodiments of the invention will be best understood by reference to the drawings, wherein like parts are designated by like numerals throughout.

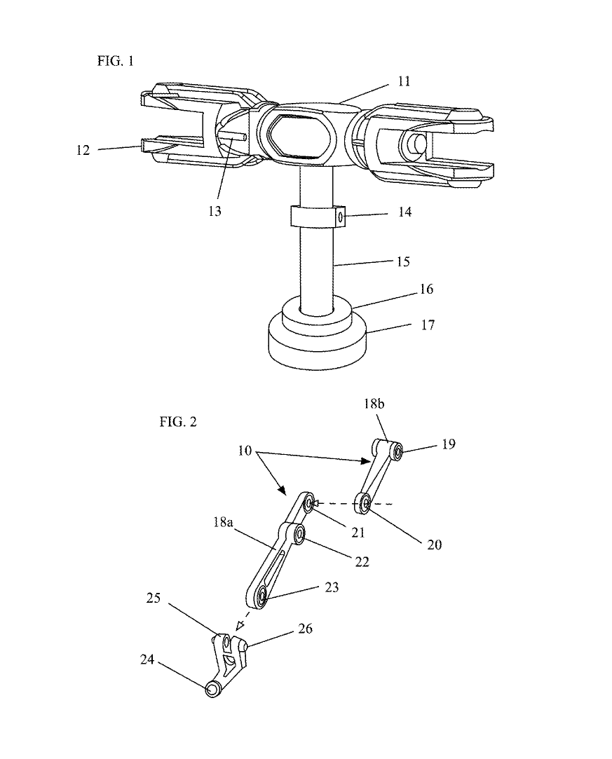

With reference to the drawings and, in particular, with reference to FIGS. 1-9, it is the primary objective of the invention 10 to improve the cyclic and collective pitch control of rotary-wing aircraft by 1) reducing vibration and shock caused by rotor blades and 2) improve the operating efficiency by utilizing leveraged pitch links that require less energy and fewer repairs and maintenance.

The invention 10 is attached to the rotor blade grip, the main rotor shaft and the swashplate arm with vibration and shock dampeners within the connectors.

The present invention 10 comprises upper and lower leverage pitch links, dampeners and connectors. The invention 10 is attached to the rotor blade grips, main rotor shaft and the rotational swashplate with connectors.

As the main rotor shaft turns, the connected invention 10 (leveraged pitch links) also rotate with the rotational swashplate. Cyclic and collective pitch control are achieved by the angle and vertical movement of the rotational swashplate.

FIG. 1 is a side perspective view of a rotary-wing head unit (11), blade holder (12), upper leveraged pitch link mount (13), leveraged pitch link mount (14), main drive shaft (15), rotating swashplate (16) and non-rotational swashplate (17).

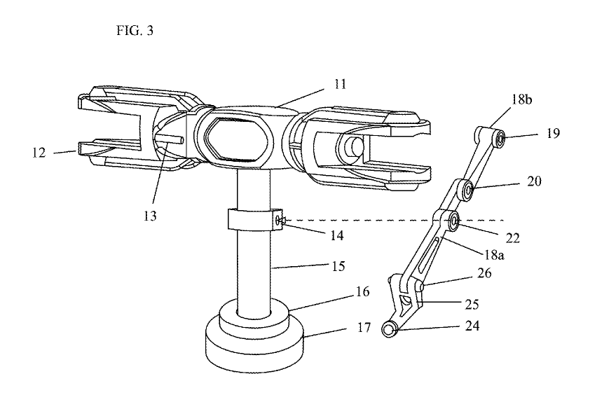

FIG. 2 is a side perspective view of the invention 10 including upper leveraged pitch link (18b) with upper mounting bushing and bearing (19) and lower mounting bushing and bearing (20). FIG. 2 also illustrates Lower leveraged pitch link (18a) with upper mounting bushing and bearing (21), middle mounting bushing and bearing (22) and lower mounting bushing and bearing (23). FIG. 2 also illustrates swashplate mounting bracket (25) with upper mounting opening (26) and lower mounting opening (24).

FIG. 3 is a side perspective view of a rotary-wing head unit (11), blade holder (12), upper leveraged pitch link mount (13), leveraged pitch link mount (14), main drive shaft (15), rotating swashplate (16) and non-rotational swashplate (17). FIG. 3 is a side perspective view of the invention 10 with upper leveraged pitch link (18b) connected to lower leveraged pitch link (18a) by mounting hardware through opening (20). FIG. 3 also illustrates the swashplate mounting bracket (25) attached to upper (18b) and lower (18a) leveraged pitch link with mounting hardware through mounting opening (22).

FIG. 3 illustrates the main shaft (15) mounting point (14) to the leveraged pitch link (18a,b).

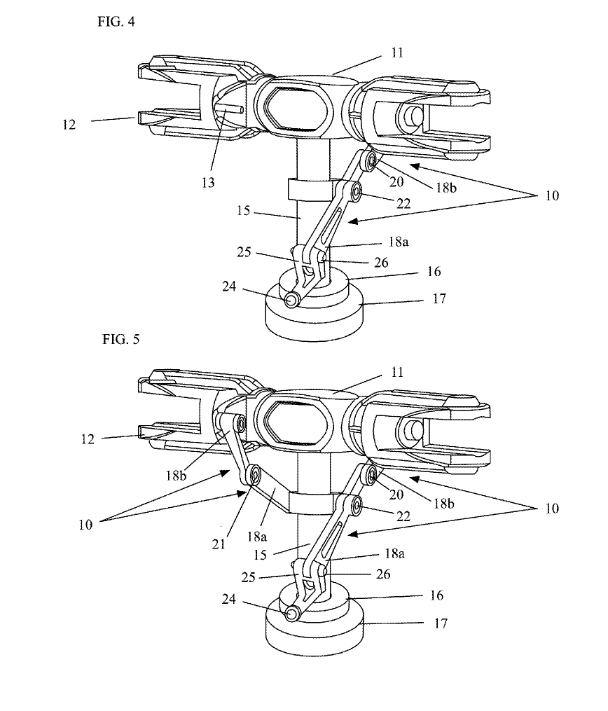

FIG. 4 is a side perspective view of a rotary-wing head unit (11), blade holder (12), upper leveraged pitch link mount (13), main drive shaft (15), rotating swashplate (16) and non-rotational swashplate (17). FIG. 4 also illustrates the side perspective view of the invention 10 with upper leveraged pitch link (18b) connected to lower leveraged pitch link (18a) by mounting hardware through opening (22).

FIG. 4 also illustrates the swashplate mounting bracket (25) attached to upper (18b) and lower (18a) leveraged pitch link with mounting hardware through mounting opening (26).

FIG. 4 also illustrates the attached leveraged pitch link (18a,b) to the main shaft (15) with mounting hardware through mounting opening (22).

FIG. 5 is a side perspective view of a rotory-wing head unit (11), blade holder (12), upper leveraged pitch link mount (13), main drive shaft (15), rotating swashplate (16) and non-rotational swashplate (17). FIG. 4 also illustrates the side perspective view of the invention 10 with upper leveraged pitch link (18b) connected to lower leveraged pitch link (18a) by mounting hardware through opening (22). FIG. 4 also illustrates the swashplate mounting bracket (25) attached to upper (18b) and lower (18a) leveraged pitch link with mounting hardware through mounting opening (26). FIG. 4 also illustrates the attached leveraged pitch link (18a,b) to the main shaft (15) with mounting hardware through mounting opening (22). FIG. 5 also illustrates another opposing leveraged pitch link (18a,b) connected to blade holder (12) with mounting opening (19).

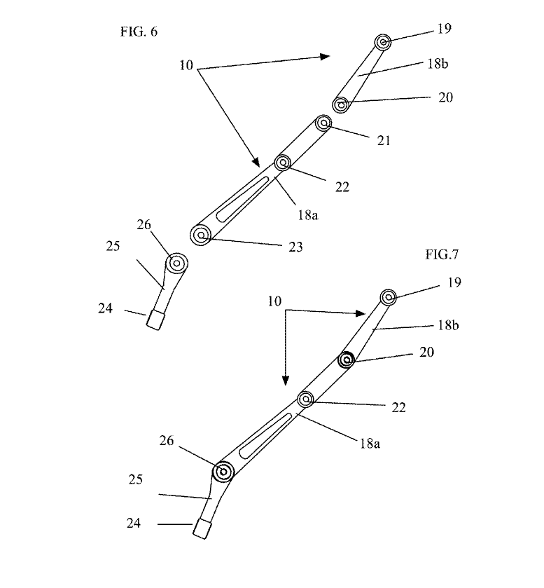

FIG. 6 is a side view of the invention 10 illustrating the separate upper leveraged pitch link (18b) with upper mounting opening (19), lower mounting opening (20), lower leveraged pitch link (18b) with upper mounting opening (21), middle mounting opening (22), lower mounting opening (23). FIG. 6 also illustrates side view of swash plate mounting bracket (25) with upper mounting opening (26) and lower mounting opening (24).

FIG. 7 is a side view of the invention (10) with upper leveraged pitch link (18b) connected to lower leveraged pitch link (18a) through mounting opening (20). FIG. 7 also illustrates the connected invention (10) attached to the swashplate mounting bracket (25) through mounting opening (26).

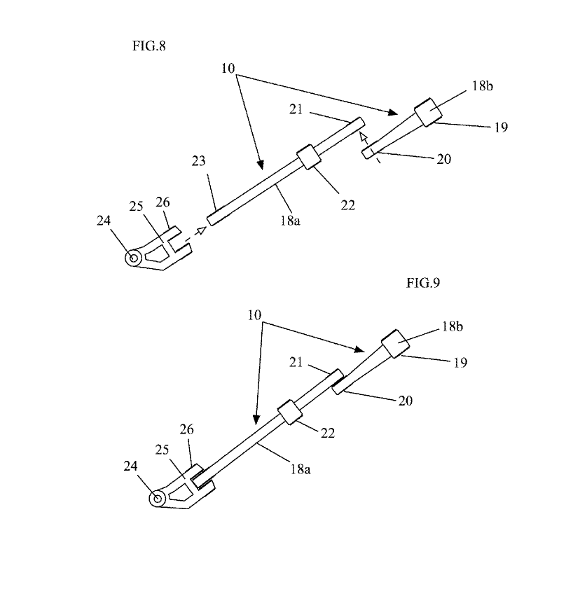

FIG. 8 is a top view of the invention (10) illustrating the separate upper leveraged pitch link (18b) with upper mounting opening (19), lower mounting opening (20), lower leveraged pitch link (18b) with upper mounting opening (21), middle mounting opening (22), and lower mounting opening (23). FIG. 6 also illustrates side view of swash plate mounting bracket (25) with upper mounting opening (26) and lower mounting opening (24).

FIG. 9 is a top view of the invention (10) with upper leveraged pitch link (18b) connected to lower leveraged pitch link (18a) through mounting opening (20). FIG. 7 also illustrates the connected invention (10) attached to the swashplate mounting bracket (25) through mounting opening (26)

1. A Leveraged Pitch Link assembly comprising:
upper and lower pitch links connected to the main rotor shaft, rotor blade grips and the rotational swashplate;
wherein the upper and lower pitch links are attached together with connectors and dampeners;
wherein a connected upper and lower pitch link assembly is attached to both surfaces of the main rotor shaft; and
wherein the upper and lower pitch link assemblies are connected to the main rotor shaft offset from their center point to create leverage.

2. A Leveraged Pitch Link assembly of claim 1, wherein the upper pitch link is attached to the rotor blade grip with dampeners and connectors;
wherein the lower pitch link is attached to the upper pitch link with dampeners and connectors;
wherein the lower pitch link is attached to the main rotor shaft with dampeners and connectors; and
wherein the lower pitch link is attached to the swashplate with dampeners and connectors.

3. A Leveraged Pitch Link assembly of claim 1, wherein the pitch links are rotated by the main rotor shaft;
wherein the pitch links connected to the rotational swashplate are altered by any change to effect cyclic and collective pitch control of the rotor blades; and
wherein the force required to change the rotational swashplate is reduced due to the leverage benefit of the leveraged pitch links.

4. A Leveraged Pitch Link assembly of claim 3, wherein the pitch links are attached with dampeners and connectors to reduce vibration and shock; and
wherein reduced vibrations and shock increase operating efficiency and life cycle affordability.

5. A Leveraged Pitch Link assembly of claim 3, wherein the leverage benefit increases the lift capacity or traditional rotary-wing aircraft;
wherein the leverage benefit allows for improved rotor blade design; and
wherein the leverage benefit improves flight control due to reduced cyclic and collective pitch movement.
